(19) United States
(12) Patent Application Publication
(10) Pub. No.: US 2011/0135137 A1
(43) Pub. Date: Jun. 9, 2011

(54) EARPHONE

(75) Inventors: Chao-Chun Chung, Taipei County (TW); Chang-Yi Lee, Taipei County (TW)

(73) Assignee: Cal-Comp Electronics & Communications Company Limited, Taipei County (TW)

(21) Appl. No.: 12/703,782

(22) Filed: Feb. 11, 2010

(30) Foreign Application Priority Data
Dec. 3, 2009 (TW) 98141366

(51) Int. Cl. H04R 1/02

(52) U.S. Cl. 381/386

(57) ABSTRACT

An earphone including an ear hanger, a connecting element, a pivot and a speaker is provided. The connecting element is fixed to the ear hanger. The pivot is hinged to the connecting element. The speaker is fixed to the pivot, in which the pivot rotates relative to the connecting element so as to drive the speaker to rotate relative to the ear hanger.

### CROSS-REFERENCE TO RELATED APPLICATION

This application claims the priority benefit of Taiwan application serial no. 98141366, filed Dec. 3, 2009. The entirety of the above-mentioned patent application is hereby incorporated by reference herein and made a part of specification.

### BACKGROUND OF THE INVENTION

1. Field of the Invention

The invention generally relates to an earphone, and more particularly to an ear-hanging type earphone.

2. Description of Related Art

With the rapid progress in science and technology, most electronic products have been developed towards light, handy and miniaturized designs. People may use miniaturized electronic products, such as radios or walkmans, anytime and anywhere. Furthermore, since personal digital products have gradually become popular, products such as MP3 players, cellular phones, personal digital assistants (PDAs) or notebook computers have grown to be indispensable in our daily life. For each of those aforementioned electronic products, in order to allow a user to listen to the audio information provided by the electronic product without disturbing the other people around, an earphone has become a necessary accessory to the electronic product. Moreover, the earphone also provides a listener better audio transmission so that the listener can clearly hear and understand the content of the audio information. In contrast to an unclear audio transmission through the air, especially when the listener is moving, for example while exercising, driving, engaging in intense movements or being in a noisy environment, the audio transmission of the earphone still would not be affected.

An earphone may be categorized as an ear-plug type earphone, an ear hanging type earphone, or an ear-cup type earphone, as well as other types of earphones. Regarding the ear-hanging type earphone, generally speaking, this type of earphone includes an ear hanger for hanging on a user's ears, and a speaker disposed at the ear hanger and arranged in the user's ear openings. However, the ear hanger and the speaker are mutually set in place, and therefore a relative position or angle cannot be adjusted. Since the sizes and shapes of ears for different users vary, the users may find that while using the ear-hanging type earphones, the speakers may not be totally fixed at the ear openings.

### SUMMARY OF THE INVENTION

An aspect of the invention provides an earphone including a speaker that may rotate relative to an ear hanger.

Another aspect of the invention provides an earphone, including an ear hanger, a connecting element, a pivot, and a speaker. The connecting element is fixed to the ear hanger. The pivot is hinged to the connecting element. The speaker is fixed to the pivot, in which the pivot rotates relative to the connecting element so as to drive the speaker to rotate relative to the ear hanger.

In one embodiment of the invention, the above-described pivot has a first through hole, the connecting element has a second through hole, and an internal conductive line of the earphone passes through the first through hole and the second through hole in sequence.

In one embodiment of the invention, the above-described first through hole and the second through hole extends along an axis, and the connecting element includes a first fixing portion and a first pivoting portion. The first fixing portion is fixed to the ear hanger, in which the second through hole is disposed in the first fixing portion. The first pivoting portion is connected to the first fixing portion, in which the pivot is hinged to the first pivoting portion along the axis, so that the first through hole is connected to the second through hole.

In one embodiment of the invention, the above-described earphone further includes a fixing plate fixed to the ear hanger. Moreover, the fixing plate has a slot, in which the connecting element is fitted in the slot.

In one embodiment of the invention, the above-described ear hanger is disposed between the connecting element and the fixing plate, the ear hanger having an opening, and the connecting element passes through the opening so as to fit in the slot.

In one embodiment of the invention, the above-described speaker includes a fixing plate, a housing, and a speaker main body. The fixing plate is fixed to the axis. The housing is fixed to the fixing plate and covers the fixing plate, the axis, and the connecting element. The speaker main body is disposed at the housing, in which the pivot uses the fixing plate to drive the housing and the speaker main body to rotate relative to the ear hanger.

In one embodiment of the invention, the above-described fixing plate has a slot, and the pivot includes a second pivoting portion and a second fixing portion. The second pivoting portion pivot is hinged to the connecting element. The second fixing portion is connected to the second pivoting portion and embedded in the slot, in which the second fixing portion has a ring-shaped spine, and the fixing plate leans against the ring-shaped spine.

In one embodiment of the invention, the above-described second fixing portion has a ring-shaped groove, and the speaker further includes a ring fitted in the ring-shaped groove, so as to press the fixing plate against the ring-shaped spine

In summary, according to the invention as embodied and broadly described herein, the connecting element is fixed to the ear hanger, and the pivot is fixed to the speaker and hinged to the connecting element, so that the pivot may rotate relative to the connecting element so as to drive the speaker to rotate relative to the ear hanger. Accordingly, a user may rotate the speaker relative to the ear hanger, so as to adjust the speaker at an angle suitable for placing the speaker in an ear opening.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of an earphone in accordance with an embodiment of the invention.

FIG. 2 is a three-dimensional view of a partial structure of the earphone depicted in FIG. 1.

FIG. 3 is a partial three-dimensional view of the earphone depicted in FIG. 1.

FIG. 4 is a three-dimensional view of the earphone depicted in FIG. 1 from another viewing angle.

FIG. 5 is an exploded view of a partial structure of the earphone depicted in FIG. 1.

### DESCRIPTION OF EMBODIMENTS

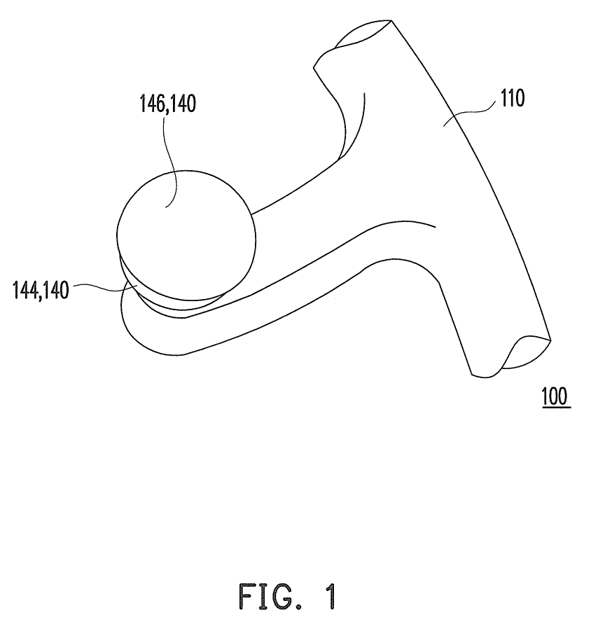

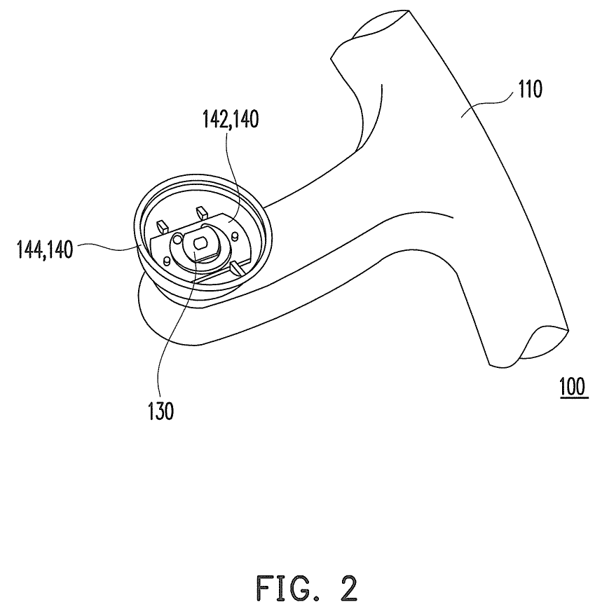

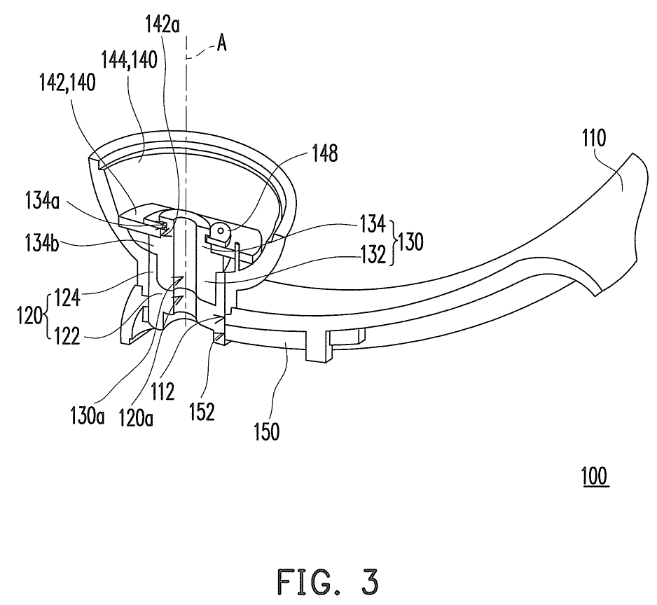

FIG. 1 is a three-dimensional view of an earphone in accordance with an embodiment of the invention. FIG. 2 is a three-dimensional view of a partial structure of the earphone depicted in FIG. 1. FIG. 3 is a partial three-dimensional view of the earphone depicted in FIG. 1. For clarity of illustration, a speaker body 146 is not illustrated in FIGS. 2-3. Referring to FIGS. 1-3, according to the present embodiment of the invention, an earphone 100 is an ear-hanging type earphone, and the earphone 100 includes an ear hanger 110, a connecting element 120, a pivot 130, and a speaker 140. The connecting element 120 is fixed to the ear hanger 110. The pivot 130 is hinged to the connecting element 120. The speaker is fixed to the pivot 130, in which the pivot 130 rotates relative to the connecting element 120 so as to drive the speaker 140 to rotate relative to the ear hanger 110.

When a user employs the earphone 100, the user may first hang the ear hanger 110 at an ear. Since the pivot 130 rotates relative to the connecting element 120 so as to drive the speaker 140 to rotate relative to the ear hanger 110, the user may adjust the speaker 140 at an angle for fitting into an ear opening. Consequently, the user may avoid an incompatibility issue between the sizes and shapes of the ear hanger 110 and the speaker 140 with the user's ears.

Referring to FIG. 3, in the present embodiment of the invention, the pivot 130 has a first through hole 130a, and the connecting element 120 has a second through hole 120a. Moreover, an internal conductive line (not drawn) of the earphone 100 may pass from the ear hanger 110 to the second through hole 120a and the first through hole 130a in sequence, so as to electrically connect to a speaker main body 146 of the speaker 140 (shown in FIG. 1). More specifically, the connecting element 120 of the present embodiment includes a first fixing portion 122 and a first pivoting portion 124. The first fixing portion 122 is fixed to the ear hanger 110 and has the aforementioned second through hole 120a. The first pivoting portion 124 connects to the first fixing portion 122, and the pivot 130 hinges to the first pivoting portion 124 along an axis A, so as to connect the first through hole 130a to the second through hole 120a, and to extend the first through hole 130a and the second through hole 120a along the axis A. Accordingly, when the pivot 130 rotates relative to the connecting element 120, the aforementioned internal conductive line is not being dragged.

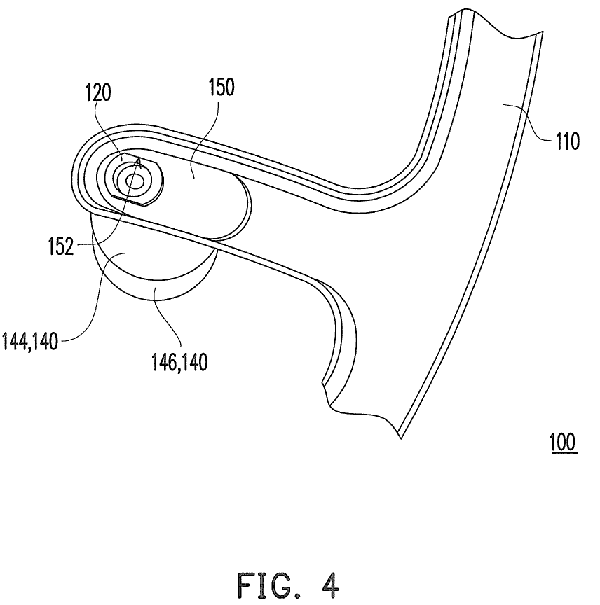

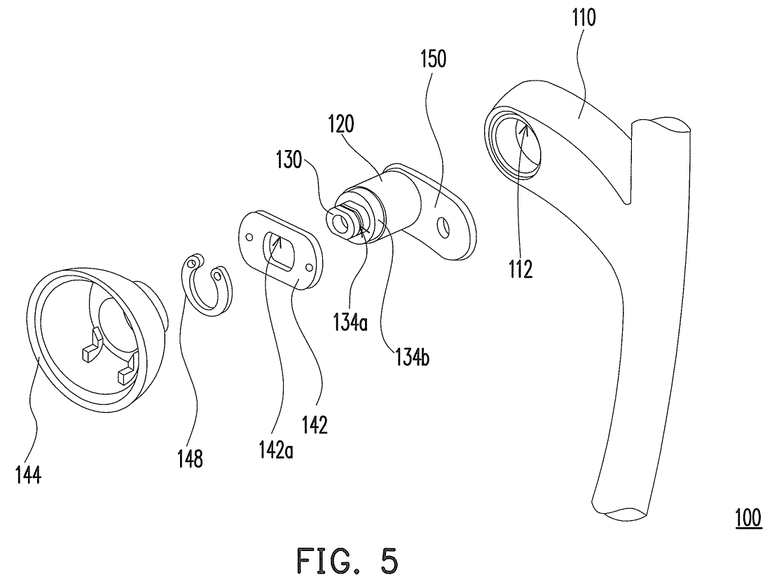

FIG. 4 is a three-dimensional view of the earphone depicted in FIG. 1 from another viewing angle. FIG. 5 is an exploded view of a partial structure of the earphone depicted in FIG. 1. Referring to FIGS. 3-5, in the present embodiment of the invention, the earphone 100 further includes a fixing plate 150 fixed to the ear hanger and having a slot 152. Herein, the connecting element 120 is fitted in the slot 152, so that the connecting element 120 can be fixed to the fixing board 150 and the ear hanger 110. Specifically, the ear hanger 110 is disposed between the connecting element 130 and the fixing plate 150, and the ear hanger 110 has an opening 112. Moreover, the connecting element 130 passes through the opening 112 to be fitted in the slot 152 of the fixing plate 150.

Furthermore, referring to FIGS. 1, 3 and 5, the speaker 140 according to the present embodiment includes a fixing plate 142, a housing 144, and a speaker main body 146 (drawn only in FIG. 1). The fixing plate 142 is fixed to the pivot 130, and the housing 144 is fixed to the fixing plate 142, so as to cover and protect the fixing plate 142, the pivot 130, and the connecting element 120. The speaker main body 146 is disposed at the housing 144, and when the pivot 130 rotates relative to the connecting element 120, the housing 144 and the speaker main body 146 are driven by the fixing plate 142 to rotate relative to the ear hanger 110.

Referring to FIGS. 3 and 5, in the present embodiment of the invention, the fixing plate 142 has a slot 142a, and the pivot 130 includes a second pivoting portion 132 and a second fixing portion 134. The second pivoting portion 132 is hinged to the first pivoting portion 124 of the connecting element 130, and the second fixing portion 134 is connected to the second pivoting portion 132 and embedded in the slot 142a. The speaker further includes a ring 148 fitted in a ring-shaped groove 134a of the second fixing portion 134, so as to press the fixing plate 142 against a ring-shaped spine 134b of the second fixing portion 134. In the present embodiment of the invention, the ring 148 is a C-shaped ring, for example.

In light of the foregoing, according to the invention as embodied and broadly described herein, the connecting element is fixed to the ear hanger, and the pivot is fixed to the speaker and hinged to the connecting element, so that the pivot may rotate relative to the connecting element so as to drive the speaker to rotate relative to the ear hanger. Accordingly, the user may rotate the speaker relative to the ear hanger, so as to adjust the speaker at an angle suitable for placing the speaker in an ear opening. Moreover, the pivot has the first through hole and the connecting element has the second through hole connected to the first through hole, so that the internal conductive line may pass from the ear hanger through the first through hole and the first through hole in sequence to electrically connect to the speaker.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An earphone, comprising:
an ear hanger;
a connecting element fixed to the ear hanger;
a pivot hinged to the connecting element; and
a speaker fixed to the pivot, wherein the pivot rotates relative to the connecting element so as to drive the speaker to rotate relative to the ear hanger.

2. The earphone as claimed in claim 1, wherein the pivot has a first through hole, and the connecting element has a second through hole, and an internal conductive line of the earphone passes through the first through hole and the second through hole.

3. The earphone as claimed in claim 2, wherein the first through hole and the second through hole extends along an axis, and the connecting element comprises:
a first fixing portion fixed to the ear hanger, wherein the second through hole is disposed in the first fixing portion; and
a first pivoting portion connected to the first fixing portion, wherein the pivot hinges to the first pivoting portion along the axis, so that the first through hole is connected to the second through hole.

4. The earphone as claimed in claim 1, further comprising a fixing plate fixed to the ear hanger and having a slot, wherein the connecting element is fitted in the slot.

5. The earphone as claimed in claim 4, wherein the ear hanger is disposed between the connecting element and the fixing plate, the ear hanger having an opening, and the connecting element passes through the opening so as to fit in the slot.

6. The earphone as claimed in claim 1, wherein the speaker comprises:
a fixing plate fixed to the axis;
a housing fixed to the fixing plate and covering the fixing plate, the axis, and the connecting element; and
a speaker main body disposed at the housing, wherein the pivot uses the fixing plate to drive the housing and the speaker main body to rotate relative to the ear hanger.

7. The earphone as claimed in claim 6, wherein the fixing plate has a slot, and the pivot comprises:
a second pivoting portion hinged to the connecting element; and
a second fixing portion connected to the second pivoting portion and embedded in the slot, wherein the second fixing portion has a ring-shaped spine, and the fixing plate leans against the ring-shaped spine.

8. The earphone as claimed in claim 7, wherein the second fixing portion has a ring-shaped groove, and the speaker further comprises a ring fitted in the ring-shaped groove, and the ring presses the fixing plate against the ring-shaped spine.
